(19) United States
(12) Patent Application Publication
(10) Pub. No.: US 2022/0173412 A1
(43) Pub. Date: Jun. 2, 2022

(54) ELECTRODE FORMING COMPOSITION, ELECTRODE, METHOD FOR MANUFACTURING THE ELECTRODE, MEMBRANE-ELECTRODE ASSEMBLY, AND FUEL CELL

(71) Applicants: HYUNDAI MOTOR COMPANY, Seoul (KR); KIA CORPORATION, Seoul (KR)

(72) Inventors: Dahee Kwak, Gunpo-si (KR); Jee Youn Hwang, Seoul (KR); Songi Oh, Suwon-si (KR); Ji-Hoon Jang, Suwon-si (KR); Eunjik Lee, Uiwang-si (KR)

(21) Appl. No.: 17/501,465

(22) Filed: Oct. 14, 2021

(30) Foreign Application Priority Data
Dec. 1, 2020 (KR) 10-2020-0165422

(51) Int. Cl. H01M 4/90; H01M 8/1004; H01M 4/86

(52) U.S. Cl. CPC H01M 4/9083; H01M 4/8626; H01M 4/8652; H01M 8/1004

(57) ABSTRACT

Disclosed is a composition for forming an electrode for a fuel cell including a composite support including a sphere-shaped support and a fiber-shaped support, active metal particles supported on the composite support, and mixed solvent including water, an alcohol solvent, and an organic solvent.

### CROSS REFERENCE TO RELATED APPLICATIONS

This application claims priority to and the benefit of Korean Patent Application No. 10-2020-0165422 filed in the Korean Intellectual Property Office on Dec. 1, 2020, the entire contents of which are incorporated herein by reference.

### BACKGROUND

### (a) Field

The present disclosure relates to a composition for forming an electrode for a fuel cell, an electrode, a method for manufacturing the electrode, a membrane-electrode assembly, and a fuel cell.

### (b) Description of the Related Art

A fuel cell is a battery cell equipped with a power generation system that directly converts chemical reaction energy such as oxidation/reduction reaction of hydrogen and oxygen contained in hydrocarbon-based fuel materials such as methanol, ethanol, and natural gas into electrical energy and is being spotlighted as a next generation clean energy source that may replace fossil energy due to high energy efficiency and eco-friendliness with low pollutant emission.

This fuel cell may have a stack configuration by stacking unit cells and produce a wide range of outputs and also, exhibit about 4 times to about 10 times higher energy density than a small lithium battery and thus attracts attention as a small and portable power source.

In the fuel cell, a stack substantially generating electricity has a structure of stacking several to tens of the unit cells composed of a membrane-electrode assembly (MEA) and a separator (also, called to be a bipolar plate), wherein the membrane-electrode assembly has a structure of having an oxidation electrode (anode or fuel electrode) and a reduction electrode (cathode or air electrode) respectively formed on both sides of an electrolyte membrane.

The fuel cell may be classified into an alkaline electrolyte fuel cell, a polymer electrolyte fuel cell (PEMFC), and the like according to a state and a type of an electrolyte, and the polymer electrolyte fuel cell has a low operating temperature of less than about 100° C., a fast start-up and response characteristics, excellent durability, and the like and thus is being spotlighted as a portable, vehicle, and home power supply.

Representative examples of the polymer electrolyte fuel cell may include a proton exchange membrane fuel cell (PEMFC) using hydrogen gas as a fuel, a direct methanol fuel cell (DMFC) using liquid methanol as a fuel, and the like.

Summarizing a reaction occurring in the polymer electrolyte fuel cell, a fuel such as hydrogen gas is supplied to the oxidation electrode, and protons (H⁺) and electrons (e⁻) are produced through oxidation reaction of the hydrogen at the reduction electrode. The produced protons are transferred to the reduction electrode through the polymer electrolyte membrane, while the produced electrons are transferred to the reduction electrode through an external circuit. At the reduction electrode, oxygen is supplied and combined with the protons and the electrons, producing water by a reduction reaction of the oxygen.

However, this fuel cell has a problem of performance deterioration due to elution and re-precipitation of a catalyst or corrosion of a support supporting the catalyst.

### SUMMARY

An embodiment provides a composition for forming an electrode for a fuel cell capable of securing a thickness of an electrode, improving mass transfer ability, improving cell output, improving ignition stability when forming an electrode, and simplifying a process.

Another embodiment provides a method of manufacturing an electrode using a composition for forming an electrode.

Another embodiment provides an electrode manufactured using a composition for forming an electrode.

Another embodiment provides a membrane-electrode assembly comprising an electrode.

Another embodiment provides a fuel cell including a membrane-electrode assembly.

According to an embodiment, a composition for forming an electrode for a fuel cell includes a composite support including a sphere-shaped support and a fiber-shaped support, active metal particles supported on the composite support, and a mixed solvent including water, an alcohol solvent, and an organic solvent.

The composition for forming the electrode may include about 70 wt % to about 95 wt % of the sphere-shaped support and about 5 wt % to about 30 wt % of the fiber-shaped support based on the total weight of the composite support.

The sphere-shaped support may include carbon black such as denka black, ketjen black, acetylene black, channel black, furnace black, lamp black, thermal black, or a combination thereof; or graphite.

The fiber-shaped support may include carbon nanofibers, graphitized carbon nanofibers, carbon nanotubes, carbon nanohorns, carbon nanowires, or a combination thereof.

The composition for forming an electrode may include about 25 wt % to about 70 wt % of water, about 25 wt % to about 70 wt % of the alcohol solvent, and about 5 wt % to about 10 wt % of the organic solvent based on the total weight of the mixed solvent.

The alcohol solvent may have a relative polarity of about 0.6 to about 0.7 based on water polarity of 1, and a boiling point of about 80° C. to about 90° C.

The alcohol solvent may include 1-propanol, 2-propanol, ethanol, acetone, or a combination thereof.

The organic solvent may have a relative polarity of about 0.3 to about 0.4 based on water polarity of 1, and a boiling point of greater than or equal to about 200° C.

The organic solvent may include N-methyl-2-pyrrolidone, dimethylformamide, dimethylsulfoxide, or a combination thereof.

According to another embodiment of the present disclosure, a method for manufacturing an electrode for a fuel cell includes preparing the aforementioned composition for forming an electrode, and coating the composition for forming an electrode to manufacture an electrode.

According to another embodiment of the present disclosure, an electrode for a fuel cell includes a composite support including a sphere-shaped support and a fiber-shaped support, active metal particles supported on the composite support, and an ionomer mixed with the composite support, and includes first pores of about 2 nm to about 20 nm, second pores of about 100 nm to about 300 nm, and third pores of about 0.5 μm to about 1 μm.

According to another embodiment of the present disclosure, a membrane-electrode assembly includes an anode and a cathode facing each other, and an ion exchange membrane between the anode and the cathode, wherein the anode, the cathode, or both are the aforementioned electrodes.

Another embodiment of the present disclosure provides a fuel cell including the aforementioned membrane-electrode assembly.

The composition for forming an electrode for a fuel cell according to an embodiment of the present disclosure can improve the cell output by securing the thickness of the electrode, improving the mass transfer ability, improving the ignition stability when forming the electrode, and simplifying the process.

### BRIEF DESCRIPTION OF THE FIGURES

FIG. 1 is a cross-sectional view schematically showing a membrane-electrode assembly according to an embodiment of the present disclosure.

FIGS. 2, 3, and 4 are photographs showing the results of confirming the dispersibility of each support and solvent in Experimental Example 2.

FIGS. 5 and 6 are photographs of the electrodes of Comparative Example 1 and Example 1 observed with microscopic images.

FIG. 7 is a graph showing the results of measuring the performance of the electrodes of Example 1 and Comparative Example 1.

### DETAILED DESCRIPTION

The advantages and features of the present disclosure and the methods for accomplishing the same will be apparent from the embodiments described hereinafter with reference to the accompanying drawings. However, the embodiments should not be construed as being limited to the embodiments set forth herein. Unless otherwise defined, all terms (including technical and scientific terms) used herein have the same meaning as commonly understood by one of ordinary skill in the art. The terms defined in a generally-used dictionary may not be interpreted ideally or exaggeratedly unless clearly defined. In addition, unless explicitly described to the contrary, the word “comprise,” and variations such as “comprises” or “comprising,” will be understood to imply the inclusion of stated elements but not the exclusion of any other elements.

Further, the singular includes the plural unless mentioned otherwise.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

According to an embodiment, a composition for forming an electrode for a fuel cell includes a composite support including a sphere-shaped support and a fiber-shaped support, active metal particles supported on the composite support, ionomer, and mixed solvent including water, an alcohol solvent, and an organic solvent.

Platinum, which is mainly used as active metal particles, is expensive. In order to reduce usage of the platinum, when a platinum-based alloy catalyst with excellent catalytic activity, for example, ultra-low platinum (0.1 mg Pt/cm²) is applied to an electrode, the electrode becomes so thin that mass transfer ability and proton conductivity may be deteriorated. Herein, it is difficult to improve performance in a low current density section and a high current density section.

Accordingly, the composition for forming an electrode according to an embodiment includes a composite support including a sphere-shaped support and a fiber-shaped support. In other words, when the fiber-shaped support is introduced into the sphere-shaped support, a pore structure in the electrode may be secured, and electric conductivity may be improved. Accordingly, an electrode thickness and pores are secured, and gas permeability are improved, and accordingly, performance of an ultra-low platinum membrane-electrode assembly may be maximized. In addition, the performance of a system rated output range may be improved through improvement of the mass transfer and the electric conductivity in the electrode.

The sphere-shaped support may have a diameter of about 10 nm to about 500 nm, or for example, about 20 nm to about 100 nm. The fiber-shaped support may have a diameter of about 1 nm to about 100 nm, or for example, about 5 nm to about 50 nm. The fiber-shaped support may have a length of about 5 nm to about 500 nm, or for example, about 5 nm to about 50 nm.

The composite support may include about 70 wt % to about 95 wt % of the sphere-shaped support and about 5 wt % to about 30 wt % of the fiber-shaped support and for example about 80 wt % to about 95 wt % of the sphere-shaped support and about 20 wt % to about 5 wt % of the fiber-shaped support based on the total weight of the composite support. When the content of the fiber-shaped support is less than about 5 wt %, there may be no effect of electrode pore formation due to the introduction of the fiber-shaped support, while when it exceeds about 30 wt %, since the solid content in the composition for forming an electrode increases, it is difficult to apply optimum contents of the dispersion solvent and ionomer and thus it may be necessary to derive new electrode manufacturing conditions.

The sphere-shaped support may include carbon black such as denka black, ketjen black, acetylene black, channel black, furnace black, lamp black, thermal black, or a combination thereof; or graphite.

The fiber-shaped support may include carbon nanofibers, graphitized carbon nanofibers, carbon nanotubes, carbon nanohorns, carbon nanowires, or a combination thereof.

The composite support may be included in an amount of about 20 wt % to about 80 wt %, and specifically about 30 wt % to about 60 wt %, based on the total weight of the solids excluding the mixed solvent in the composition for forming an electrode. When the content of the composite support is less than about 20 wt %, it may be difficult to provide a sufficient area for the active metal particles to be supported, while when it exceeds about 80 wt %, the performance may be deteriorated due to the small number of supported active metal particles.

The active metal particles participate in the reaction of the fuel cell, and any available catalyst may be used, and specifically, a platinum-based catalyst may be used.

The platinum-based catalyst may include platinum, ruthenium, osmium, a platinum-ruthenium alloy, a platinum-osmium alloy, a platinum-palladium alloy, and a platinum-M alloy, wherein M is Ga, Ti, V, Cr, Mn, Fe, Co, Ni, Cu , Zn, Sn, Mo, W, Rh, Ru, or a mixture thereof, may be used.

The active metal particles may be included in an amount of about 20 wt % to about 80 wt %, and specifically about 30 wt % to about 60 wt %, based on the total weight of the solids excluding the mixed solvent in the composition for forming an electrode. When the content of the active metal particles is less than about 20 wt %, the activity may be reduced, while when it exceeds about 80 wt %, the active area may be reduced due to aggregation of the catalyst particles, so that the catalytic activity may be reduced conversely.

In addition to the active metal particles and the composite support, the electrode may further include an ionomer to improve adhesion of the electrode and transfer protons.

As the ionomer, a polymer resin having proton conductivity may be used, and specifically, a polymer resin having at least one cation exchange group selected from a sulfonic acid group, a carboxylic acid group, a phosphoric acid group, a phosphonic acid group, and a derivative thereof at the side chain may be used.

The ionomer may be included in an amount of about 5 wt % to about 50 wt %, for example, about 20 wt % to about 40 wt %, based on the total weight of the solid content excluding the mixed solvent in the composition for forming an electrode. When the content of the ionomer is less than about 5 wt %, the conductivity may be lowered due to insufficient supply of ion conductivity, and thus the electrochemical performance may be reduced. When it exceeds about 40 wt %, the ionomers may be agglomerated in the electrode, and the mass transfer resistance may be increased due to a decrease in the permeability of the reaction gas, and thus the electrochemical performance may be deteriorated.

As described above, when the composite support is introduced to improve the performance of the rated output range of the fuel cell through the improvement of mass transfer and electrical conductivity within the electrode, the effect of introducing the composite support during the manufacture of the membrane-electrode assembly through the existing electrode formation process may be insignificant.

Since a composition for forming an electrode is composed of a support on which active metal particles are supported, an ionomer, and a solvent, a dispersion degree of the composition for forming an electrode has a great influence on a structure and performance of the electrode. However, since the composition for forming an electrode including the composite support hardly secures dispersibility and uniform distribution, an effect of the composite support is insignificant.

Accordingly, the composition for forming an electrode according to an embodiment includes a mixed solvent including water, an alcohol solvent, and an organic solvent.

The alcohol solvent is mainly used as a solvent for the composition for forming an electrode because it has excellent dispersibility for the carbon material used as the support. However, the alcohol solvent is an ignition solvent and has poor ignition stability in the slurry process unit.

Accordingly, water is further added as a non-ignition solvent, and thereby the ignition stability of the slurry process unit may be improved, the process may be simplified, and the formation of the electrode structure may be affected according to the volatility of the solvent.

However, since a composite support in general has insufficient dispersibility in water, when water and alcohol are included as a solvent, the composite support may be agglomerated.

Accordingly, an organic solvent may be further added thereto, to improve dispersibility of the composite support. The organic solvent has a high boiling and point and, when applied to an electrode, may control a pore size of the electrode by its slow drying process, and suppress particle agglomeration of the catalyst and the ionomer and improve dispersibility of the catalyst and the ionomer.

The alcohol solvent may have relative polarity of about 0.6 to about 0.7 based on water polarity of 1, and a boiling point of about 80° C. to about 90° C. When the relative polarity and the boiling point of the alcohol solvent are within the ranges, after coating the composition for forming an electrode, the alcohol solvent may be fast evaporated and volatilized during the drying of the electrode and form pores, wherein the pores may be formed to have different sizes when used with solvents with different boiling points.

The alcohol solvent satisfying these conditions may include 1-propanol, 2-propanol, ethanol, acetone, or a combination thereof.

The organic solvent may have a relative polarity of about 0.3 to about 0.4 based on water polarity of 1, and a boiling point of greater than or equal to about 200° C. When the relative polarity and the boiling point of the organic solvent are within the ranges, the organic solvent may affect formation of a catalyst layer depending on dispersibility and coating quality of the composition for forming an electrode and improve slurry dispersibility to obtain different fuel cell performance characteristics according to distribution/size of the ionomer dispersed in the composition for forming an electrode and also, has a high boiling point like alcohol and thus may control a pore size of the electrode by a slow volatilization rate.

The organic solvent satisfying these conditions may include N-methyl-2-pyrrolidone, dimethylformamide, dimethylsulfoxide, or a combination thereof.

The composition for forming an electrode may include about 25 wt % to about 70 wt % of water, about 25 wt % to about 70 wt % of the alcohol solvent, and about 5 wt % to about 10 wt % of the organic solvent, and for example about 30 wt % to about 50 wt % of water, about 50 wt % to about 70 wt % of the alcohol solvent, and about 5 wt % to about 10 wt % of the organic solvent based on the total weight of the mixed solvent.

When the content of the water is less than about 25 wt %, it may be difficult to improve the ignition stability of the process unit of the composition for forming an electrode, while when it exceeds 70 wt %, dispersibility of the carbon material in water is not good, and the coating property of the composition for forming an electrode may be reduced due to particle agglomeration. When the content of the alcohol solvent is less than about 25 wt %, dispersibility of the composition for forming an electrode may be reduced, while when it exceeds about 70 wt %, it is difficult to improve ignition stability, and since the solvent volatilizes quickly relative to water, it is difficult that a desired electrode pore structure is formed. When the content of the organic solvent is less than about 5 wt %, the effect of improving the dispersibility of the composition for forming an electrode may be insignificant, while when it exceeds about 10 wt %, since the ionomer and the catalyst are rather agglomerated, the particle size of the composition for forming an electrode increases, and the organic solvent may poison the catalyst.

A method for manufacturing an electrode for a fuel cell according to another embodiment of the present disclosure includes preparing a composition for forming an electrode according to an embodiment, and coating the composition for forming an electrode to manufacture an electrode.

First, the composition for forming an electrode including the composite support, active metal particles, ionomer, and a mixed solvent is prepared.

Since the description of each of the composite support, the active metal particle, the ionomer, and the mixed solvent is the same as described above, a repetitive description will be omitted. Hereinafter, a method for manufacturing an electrode using these will be mainly described.

After adding the composite support, the active metal particles, and the ionomer to a mixed solvent, the composition for forming an electrode is prepared through any one dispersion method selected from ultrasonic dispersion, stirring, three-roll milling, planetary stirring, high-pressure dispersion, and a mixed method thereof.

The composite support and the active metal particles may be mixed, respectively, or the composite support on which the active metal particles are supported may be mixed. The catalyst in which the active metal particles are supported on each of the sphere-shaped support and the fiber-shaped support may be commercially available or prepared by supporting the active metal particles on each of the composite supports. Since the process of supporting the active metal particles on the sphere-shaped support or the fiber-shaped support is widely known in the art, the detailed description thereof is omitted herein, but may be easily understood by those skilled in the art.

Next, an electrode is manufactured by coating the composition for forming an electrode.

The manufacturing of the electrode may include coating the composition for forming an electrode on a release film to prepare an electrode and further transferring the electrode to an ion exchange membrane. However, the present disclosure is not limited thereto, but the composition for forming an electrode may be directly coated on the ion exchange membrane to form the electrode.

When the composition for forming an electrode is coated on the release film, the composition for forming an electrode in which an active material is dispersed may be continuously or intermittently transported to a coater and then, directly coated to have a dry thickness of about 10 μm to about 200 μm on the release film.

An electrode for a fuel cell according to another embodiment of the present disclosure includes a composite support including a sphere-shaped support and a fiber-shaped support, active metal particles supported on the composite support, and an ionomer mixed with the composite support.

Since the description of each of the composite support, the active metal particle, and the ionomer is the same as described above, a repetitive description will be omitted.

As the electrode is manufactured using a composition for forming an electrode including the composite support and the mixed solvent, first pores of about 2 nm to about 20 nm, second pores of about 100 nm to about 300 nm, and third pores of about 0.5 μm to about 1μm may be included.

The first pores are mesopores of about 2 nm to about 20 nm, and are pores formed between sphere-shaped carbon particles. The second pores are macropores of about 100 nm to about 300 nm, and are pores formed between agglomerates of spherical carbon particles on which active metal particles are supported. The second pore serves as a pathway for mass transfer.

However, the second pores alone may not secure smooth supply of raw materials, and accordingly, additional pores for moving a large amount of reactant and discharging generated water in the high current density region need to be formed. Third pores may have a size of about 0.5 μm to about 1 μm and are formed by using the fiber-shaped support and the mixed solvent.

In other words, a pore size of the electrode is controlled by a slow drying process due to a high boiling point of the organic solvent when applied to the electrode, and the composite support on which the active metal particle is supported and the ionomer may be suppressed from particle agglomeration by improving distribution of the composite support and the ionomer.

In addition, as the mixed solvent includes three different types of solvents, three different pore sizes are formed in the electrode due to an evaporation temperature difference of the solvents, obtaining a diffusion pathway for mass transfer.

A membrane-electrode assembly according to another embodiment of the present disclosure includes an anode and a cathode facing each other, and an ion exchange membrane between the anode and the cathode, wherein the anode electrode. Any one selected from an anode electrode, a cathode electrode, and both may include the electrode according to an embodiment of the present disclosure. Since the description of the electrode and the method of manufacturing the electrode is the same as described above, a repetitive description will be omitted.

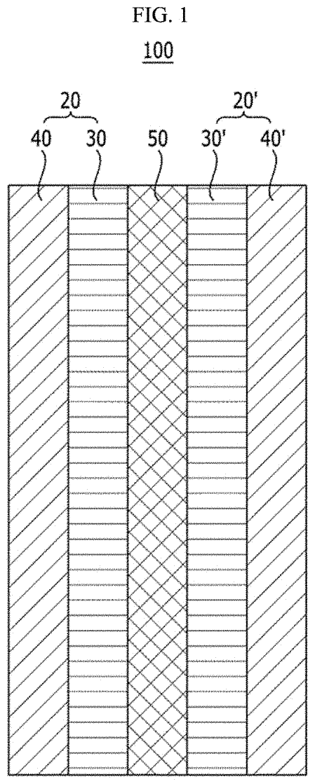

FIG. 1 is a cross-sectional view schematically illustrating a membrane-electrode assembly. Referring to FIG. 1, the membrane-electrode assembly 100 includes an ion exchange membrane 50 and electrodes 20 and 20′ disposed on both surfaces of the ion exchange membrane 50, respectively. The electrodes 20 and 20′ include electrode substrates 40 and 40′ and catalyst layers 30 and 30′ formed on the surface of the electrode substrates 40 and 40′. In order to facilitate material diffusion in the electrode substrates 40 and 40′ between the electrode substrates 40 and 40′ and the catalyst layers 30 and 30′, microporous layer (not shown) including conductive fine particles such as carbon powder or carbon black may be further included.

In the membrane-electrode assembly 100, the electrode 20 disposed on one surface of the ion exchange membrane 50 and having an oxidation reaction of producing protons and electrons from a fuel transferred from the catalyst layer 30 through the electrode substrate 40 is called to be an anode, and the other electrode 20′ disposed on the other surface of the ion exchange membrane 50 and having a reduction reaction of producing water from the protons supplied through the ion exchange membrane 50 and an oxidizing agent transferred from the catalyst layer 30′ through the electrode substrates 40′ is called to be a cathode.

The catalyst layers 30 and 30′ of the anode 20 and cathode 20′ include an electrode according to an embodiment of the present disclosure including a catalyst and an ionomer.

The ion exchange membrane 50 includes an ion conductor. The ion conductor may be a cation conductor having a cation exchange group such as a proton, or an anion conductor having an anion exchange group such as a hydroxy ion, carbonate, or bicarbonate.

As the electrode substrates 40 and 40′, a porous conductive substrate may be used so that hydrogen or oxygen may be smoothly supplied. Representative examples thereof may include carbon paper, carbon cloth, carbon felt, or metal cloth (a porous film composed of a fibrous metal cloth or a metal film formed on the surface of a cloth formed of polymer fibers) may be used, but are not limited thereto. In addition, a water repellent treatment for the electrode substrates 40 and 40′ with a fluorine-based resin may be performed because it is possible to prevent a reduction of reactant diffusion efficiency due to water generated when the fuel cell is driven.

The membrane-electrode assembly 100 may be manufactured according to a conventional membrane-electrode assembly manufacturing method, except that the electrode according to the present disclosure is used as the anode 20 or the cathode 20′.

A fuel cell according to another embodiment of the present disclosure includes a membrane-electrode assembly.

Hereinafter, specific embodiments of the disclosure are presented. However, the examples described below are only for specifically illustrating or explaining the disclosure, and the scope of the disclosure is not limited thereto.

### Experimental Example 1: Performance Measurement According to the Ratio of Composite Support

Carbon black (diameter: 0.1 μm) as a sphere-shaped support and carbon nanofiber (diameter: 0.1 length: 0.3 μm to 0.4 μm) as a fiber-shaped support were adjusted into each weight ratio of 10:0 (Sample 1), 9.5:0.5 (Sample 2), 9:1 (Sample 3), and 8:2 (Sample 4) to manufacture electrodes, and the electrodes were respectively cut into a required size and then, transferred on both sides of a polymer electrolyte membrane, obtaining a membrane electrode assembly. A fuel cell performance evaluation equipment was used to measure performance under conditions of hydrogen of 350 sccm, air of 2500 sccm, 65° C., and 1 bar, and the results are shown in Table 1.

TABLE 1

| | Composite support ratio | Current Density (A/cm²) | | HFR |
|---|---|---|---|---|
| | (sphere-shaped: | @ 0.7 | @ 0.6 | (mΩ · |
| | fiber-shaped) | V | V | cm²) |
| Sample 1 | 10:0 | 1.112 | 1.421 | 66.7 |
| Sample 2 | 9.5:0.5 | 1.157 | 1.548 | 65.0 |
| Sample 3 | 9:1 | 1.166 | 1.567 | 69.2 |
| Sample 4 | 8:2 | 1.173 | 1.494 | 59.4 |

Referring to Table 1, according to an additional ratio of the fiber-shaped support, there was an effect of improving the performance in a mass transfer region (in a range of 1.0 A/cm² or more), and Sample 3 (9:1) exhibited performance improvement of about 146 mA/cm².

### Experimental Example 2: Confirmation of Dispersibility and Particle Size Analysis According to Support and Solvent

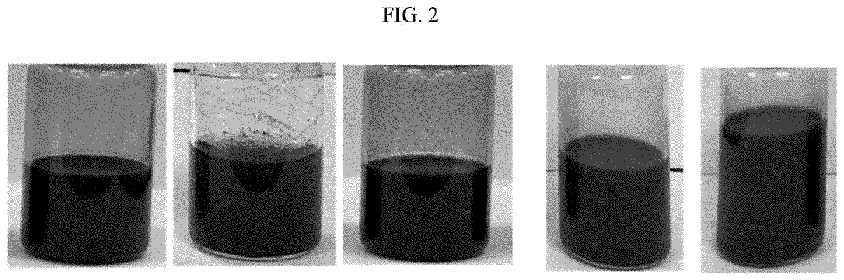

When carbon nanofiber (diameter: 0.1 length: 0.3 μm to 0.4 μm) as a fiber-shaped support, carbon black (diameter: 0.1 μm) as a sphere-shaped support, and a composite support including both of them were respectively used as a support, and in addition, 2 types of mixed solvent using an alcohol solvent of 2-propanol (alcohol solvent:water=1:1), 3 types of mixed solvent including 10 wt % of N-methyl-2-pyrrolidone as an organic solvent (alcohol solvent:water=1:1, 10 wt % of organic solvent), and 3 types of mixed solvent including 50 wt % of the organic solvent (alcohol solvent:water=1:1, 50 wt % of organic solvent) were respectively used as a solvent, and then, dispersibility depending to the supports and the solvents was examined, and the results are shown in FIGS. 2 to 4.

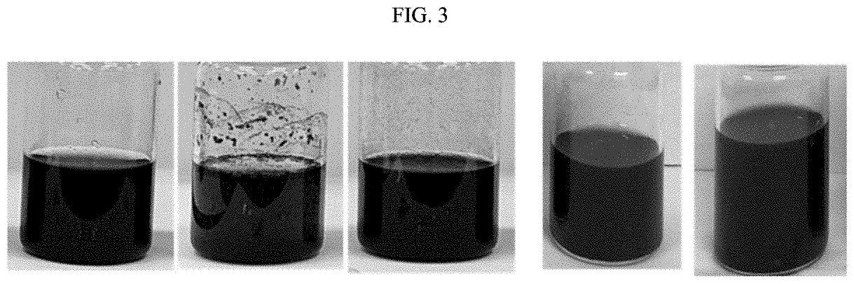

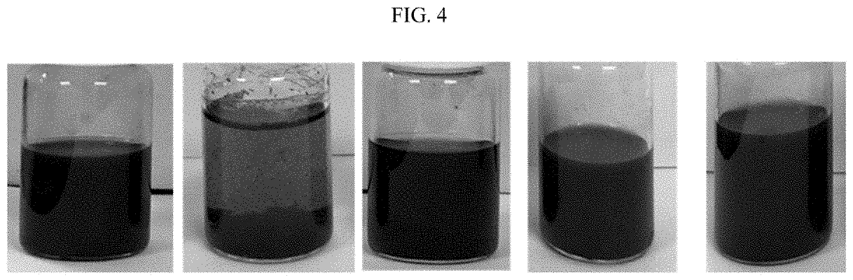

FIG. 2 exhibits the result of using the fiber-shaped support as a support, FIG. 3 exhibits the result of using the sphere-shaped support as a support, and FIG. 4 exhibits the result of using the composite support as a support.

In FIGS. 2 to 4, each photograph sequentially from the left shows the results of using alcohol solvent, water, 2 types of mixed solvent, 3 types of mixed solvent (10 wt % of an organic solvent), and 3 types of mixed solvent (50 wt % of an organic solvent).

Referring to FIGS. 2 to 4, all supports exhibited insufficient dispersibility in water but excellent dispersibility in the alcohol solvent. In the 2 types of mixed solvent, aggregation of particles by water was slightly observed.

However, when the organic solvent was added thereto, dispersibility was improved when examined with naked eyes.

In addition, particle size analysis results for each support and solvent are summarized in Table 2.

TABLE 2

| | | | | Three | Three |
|---|---|---|---|---|---|
| | | | | types of | types of |
| | | | | mixed | mixed |
| | | | Two | solvent | solvent |
| | | | types | (10 wt | (50 wt |
| | | | of | % of | % of |
| Average | Alcohol | | mixed | organic | organic |
| size (μm) | solvent | Water | solvent | solvent) | solvent) |
| Fiber-shaped | 7.9 | 10.8 | 7.6 | 12.3 | 11.3 |
| support | | | | | |
| Sphere-shaped | 6.4 | 13.2 | 11.0 | 6.0 | 18.3 |
| support | | | | | |
| Composite | 14.6 | 9.8 | 15.8 | 6.5 | 7.9 |
| support | | | | | |

Referring to Table 2, when the 3 types of mixed solvent including 10 wt % of an organic solvent was used, a particle size became smaller except for that of the fiber-shaped support, improving dispersibility.

In other words, when an organic solvent was added thereto, compared with an alcohol solvent, water, and 2 types of mixed solvent, dispersibility of particles was improved.

However, when 50 wt % of the organic solvent was added, particles were somewhat agglomerated, slightly increasing a particle size.

Accordingly, the 3 types of mixed solvent used in an electrode slurry process controlled pores of an electrode and also, suppressed particle agglomeration of a catalyst and an ionomer and thus controlled a size of the ionomer, improving performance of the electrode.

### Experimental Example 3: Microscopic Image Observation of Electrodes

The electrode of Example 1 was manufactured by using a composite support including carbon nanofiber (diameter: 0.1 μm, length: 0.3 μm to 0.4 μm) as a fiber-shaped support and carbon black (diameter: 0.1 μm) as a sphere-shaped support and 3 types of mixed solvent including 10 wt % of N-methyl-2-pyrrolidone as an organic solvent (alcohol solvent:water=1:1, 10 wt % of the organic solvent) as a solvent.

An electrode of Comparative Example 1 was manufactured by using the same composite support as Example 1 as a support but 2 types of a mixed solvent (alcohol solvent:water=1:1).

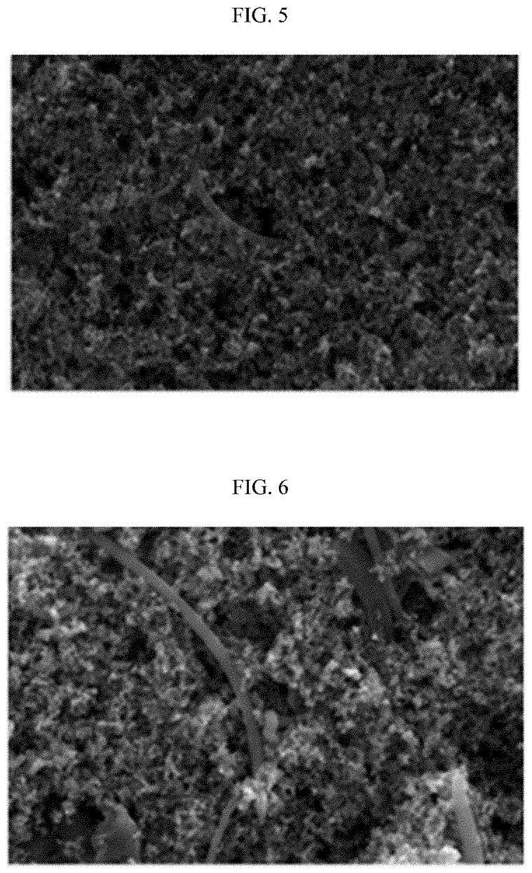

The electrodes of Example 1 and Comparative Example 1 were examined through microscope images, and the results are shown in FIGS. 5 and 6.

FIG. 5 is a microscope image of the electrode of Comparative Example 1, and FIG. 6 is a microscope image of the electrode of Example 1.

Referring to FIGS. 5 and 6, a pore size of the electrode was controlled by a slow drying process due to a high boiling point of the organic solvent, and distributions of catalyst and ionomer were improved.

In addition, the electrode of Example 1 included first pores of about 2 nm to about 20 nm, second pores of about 100 nm to about 300 nm, and third pores of about 0.5 μm to about 1 μm.

### Experimental Example 4: Measurement of Electrode Performance

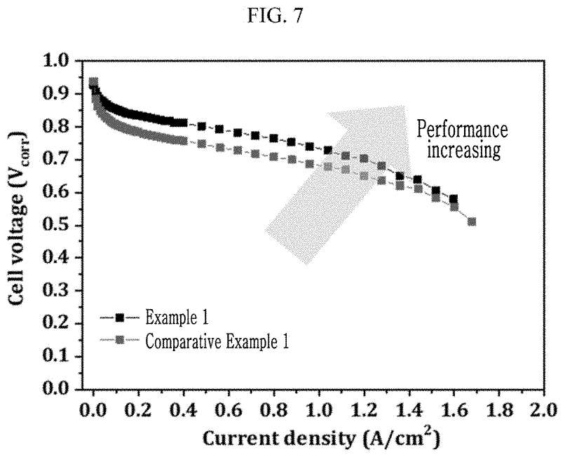

The electrodes of Example 1 and Comparative Example 1 which were manufactured in Experimental Example 3 were measured with respect to electrode performance by using a low temperature-type PEMFC test station, and the results are shown in FIG. 7.

Referring to FIG. 7, as for the electrode of Example 1, the mixed solvent further included the organic solvent and thus improved dispersibility of the composite support, and when applied to the electrode, the pore size of the electrode was controlled by the slow drying process due to the high boiling point of the organic solvent, the catalyst and ionomer were suppressed from particle agglomeration, and distributions of the catalyst/ionomer were improved, resultantly improving electrode performance, compared with the electrode of Comparative Example 1.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

1. A composition for forming an electrode for a fuel cell, comprising:
a composite support including a sphere-shaped support and a fiber-shaped support;
active metal particles supported on the composite support; and
a mixed solvent including water, an alcohol solvent, and an organic solvent.

2. The composition of claim 1, wherein the composition for forming an electrode comprises about 70 wt % to about 95 wt % of the sphere-shaped support and about 5 wt % to about 30 wt % of the fiber-shaped support based on the total weight of the composite support.

3. The composition of claim 1, wherein the sphere-shaped support comprises carbon black including denka black, ketjen black, acetylene black, channel black, furnace black, lamp black, thermal black, or a combination thereof; or graphite.

4. The composition of claim 1, wherein the fiber-shaped support comprises carbon nanofibers, graphitized carbon nanofibers, carbon nanotubes, carbon nanohorns, carbon nanowires, or a combination thereof.

5. The composition of claim 1, wherein the composition for forming an electrode comprises about 25 wt % to about 70 wt % of water, about 25 wt % to about 70 wt % of the alcohol solvent, and about 5 wt % to about 10 wt % of the organic solvent based on the total weight of the mixed solvent.

6. The composition of claim 1, wherein the alcohol solvent has a relative polarity of about 0.6 to about 0.7 based on water polarity of 1, and a boiling point of about 80° C. to about 90° C.

7. The composition of claim 1, wherein the alcohol solvent comprises 1-propanol, 2-propanol, ethanol, acetone, or a combination thereof.

8. The composition of claim 1, wherein the organic solvent has a relative polarity of about 0.3 to about 0.4 based on water polarity of 1, and a boiling point of greater than or equal to about 200° C.

9. The composition of claim 1, wherein the organic solvent comprises N-methyl-2-pyrrolidone, dimethyl formamide, dimethylsulfoxide, or a combination thereof.

10. A method for manufacturing an electrode for a fuel cell, comprising:
preparing the composition for forming an electrode of claim 1; and
coating the composition for forming an electrode to manufacture an electrode.

11. An electrode for a fuel cell, comprising:
a composite support including a sphere-shaped support and a fiber-shaped support;
active metal particles supported on the composite support; and
an ionomer mixed with the composite support,
the ionomer having first pores of about 2 nm to about 20 nm, second pores of about 100 nm to about 300 nm, and third pores of about 0.5 μm to about 1 μm.

12. A membrane-electrode assembly, comprising:
an anode and a cathode facing each other; and
an ion exchange membrane between the anode and the cathode,
wherein the anode, the cathode, or both comprise the electrode of claim 11.

13. A fuel cell comprising the membrane-electrode assembly of claim 12.
